(19) United States
(12) Patent Application Publication
(10) Pub. No.: US 2011/0030516 A1
(43) Pub. Date: Feb. 10, 2011

(54) WRENCH COUPLING DEVICE

(76) Inventor: William R. Hodges, JR., Watkinsville, GA (US)

Correspondence Address: MITCH HARRIS, LLC - GENERAL, P.O. BOX 7998, ATHENS, GA, 30604, US

(21) Appl. No.: 12/538,202

(22) Filed: Aug. 10, 2009

(51) Int. Cl. B25B 23/00; B23P 11/00

(52) U.S. Cl. 81/180.1; 29/525.01

(57) ABSTRACT

A wrench coupling device provides for temporary construction of wrench combinations for length extension and/or avoiding obstacles in an engine compartment or other location where nuts are not directly accessible using a standard wrench. The coupling device has a pair of heads adapted for fitting a wrench thereto, which may be hexagonal or another polygonal shape that mates with the teeth and/or faces of a wrench end. One or both of the heads may be fitted with o-rings or magnets to removably secure a wrench with a friction/magnetic link. The ends of the heads may be threaded to accept cover plates that secure the device to the wrenches in a more permanent configuration in which the wrenches will be secured to the coupling device until the cover plates are removed.

### BACKGROUND OF THE INVENTION

1. Field of the Invention

The present invention relates generally to mechanical hand tools, and more particularly, to a coupling device by which wrenches can be mechanically coupled together.

2. Description of the Related Art

Mechanics will interlock two wrenches by placing the jaws of an open-end wrench into a box end or jaws of another wrench in order to increase the effective length of a wrench, thereby increasing the torque that is applied in rotation for a particular level of rotational force at the end of the wrench set-up opposite the nut being rotated. Two wrenches will also sometimes be placed together in order to avoid an obstacle that would block a longer wrench. However, such coupling is only a loose connection and the mechanic must typically continually maintain pressure on the wrench set-up in order for the set-up to remain together.

Wrenches such as those disclosed in U.S. Pat. No. 5,931,066 provide for extending the length of a wrench, but do not provide arbitrary angles for avoiding obstacles, other than their possible use in the loose connection described above for ordinary wrenches. While at times it is desirable to be able to detach a wrench from a wrench setup, for example when some rotation has been accomplished and the operator wishes to re-set the angle at which force is applied by moving one of the wrenches. Further, the wrenches disclosed in the above-referenced U.S. Patent are specialty products with a cost incurred for each wrench so fabricated.

Therefore, it would be desirable to provide a mechanism for extending the reach of an ordinary wrench, avoiding obstacles in the rotational path of the wrench at low overall cost. It would further be desirable to provide such a mechanism that secures the wrenches together in a rigid manner, but still provides easy re-set of the rotational angle if such a configuration is desirable.

### SUMMARY OF THE INVENTION

The above objectives, among others, are achieved in a wrench coupling device and a method for coupling multiple wrenches together.

The wrench coupling device has a device body with a pair of coupler heads disposed at each end. The coupler heads are adapted for receiving a head of a wrench and are fixed such that two wrenches are secured at a fixed rotational angle when secured to the coupler. A shoulder may be disposed between the coupler heads to prevent the coupler head from passing completely through a wrench head

The coupler heads may have threaded holes at their ends for receiving cover plates having threaded studs extending from the plates. Alternatively, or in combination, a channel may be provided around the circumference of one or both coupler heads and an o-ring inserted therein for providing a friction/compression retaining mechanism. Also alternatively, magnets may be provided on a shoulder of the device, or elsewhere, to magnetically retain a wrench to the coupler. The coupler heads may be hexagonal or other polygonal shapes compatible with wrench heads, and each of the coupler heads may have a different size, so that a pair of wrenches from a single set and having different sizes can be used with the device.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein like reference numerals indicate like components, and:

FIG. 1A is an illustration of a wrench coupling device in accordance with an embodiment of the invention.

FIG. 1B is a perspective view and FIG. 1C is a side view of a wrench coupling device in accordance with another embodiment of the invention.

FIG. 1C is an illustration of a wrench coupling device in accordance with yet another embodiment of the invention.

FIG. 2 is an illustration of a wrench set-up including a coupling device in accordance with an embodiment of the invention.

FIG. 3 is an illustration of a wrench set-up in accordance with an embodiment of the invention in use.

### DESCRIPTION OF ILLUSTRATIVE EMBODIMENT

The present invention is a wrench coupling device and method that facilitates coupling of two or more standard wrenches to increase the effective length of a wrench to increase torque radius and/or to avoid obstacles by setting various angles between the wrenches. The wrenches may be rigidly secured with detachable cover plates, or detachably secured by a friction mechanism or magnets.

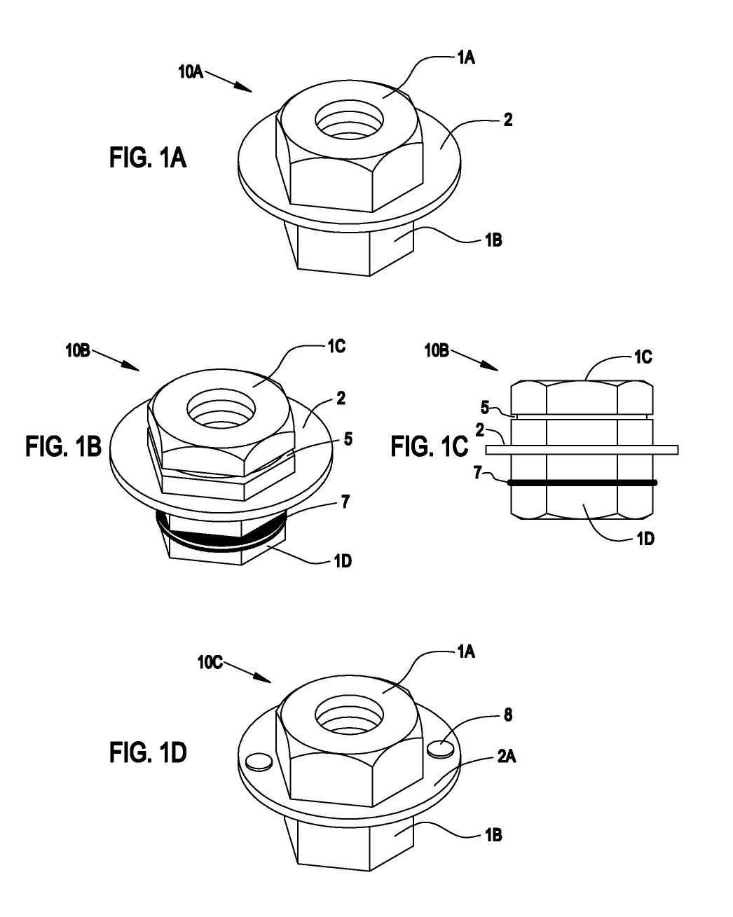

Referring now to FIG. 1, a wrench coupling device 10A in accordance with an embodiment of the invention is shown. Wrench coupling device 10A has a generally solid device body with coupler heads 1A, 1B in the shape of a hex nut disposed at each end. Coupler heads 1A and 1B are adapted for receiving corresponding wrench heads. In the exemplary embodiment coupler heads 1A and 1B are hexagonal profile heads, but may alternatively be a polygon with a larger number of sides such as a 12-sided profile for use specifically with 12-sided box end wrenches. The depicted hexagonal coupler heads 1A and 1B are compatible with both hexagonal and 12-sided box end wrenches, as well as open end wrenches. Coupler heads 1A and 1B are generally of two different standard sizes, in order to facilitate coupling of two wrenches from the same set, and the two different sizes may skip a size, so that double-ended wrench sets having adjacent sizes on one wrench can still be used to provide two wrenches that are compatible with wrench coupling device 10A.

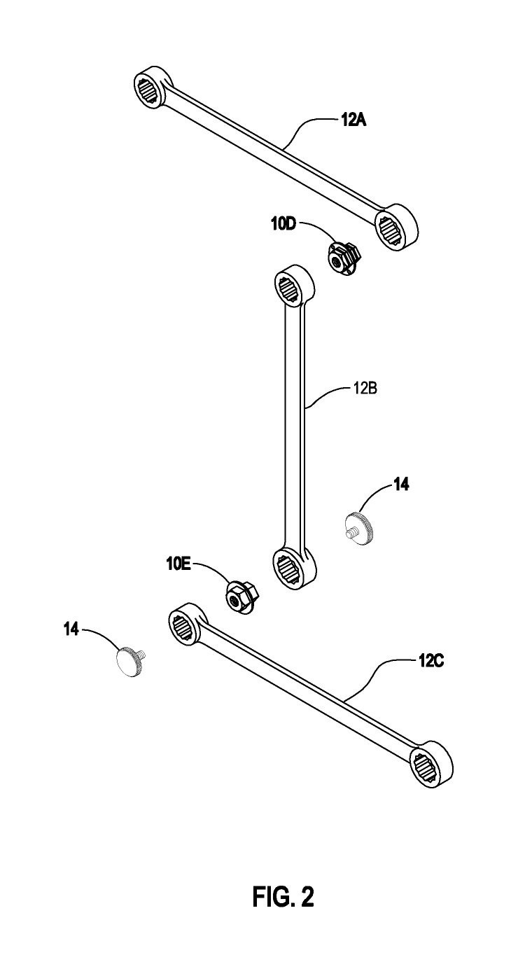

A shoulder 2 contacts a face of the wrench heads on each side, and prevents the movement of wrench coupling device 10A completely through the wrench head. As will be illustrated in further detail below, there are several mechanisms provided for securing wrenches to the coupling device by preventing them from sliding off of coupler heads 1A and 1B, and shoulder 12 prevents wrench heads from sliding too far in the other direction. Coupler heads 1A and 1B have threaded holes for accepting a removable cover plate, which will be described in further detail below with reference to FIG. 2.

Referring now to FIG. 1B, a wrench coupling device 10B in accordance with another embodiment of the present invention is shown. Wrench coupling device 10B is similar to wrench coupling device 10A of FIG. 1A, so only differences between them will be described below. Coupling heads 1C and 1D of wrench coupling device 10B have channels 5 cut around their circumference, for accepting an o-ring 7. When a wrench is forced over coupling head 1D, o-ring 7 compresses and provides a force against the inside wall(s) of the wrench's head, increasing the friction between wrench coupling device 10B and the wrench head, and providing a detachable coupling that still secures the wrench to wrench coupling device 10B unless sufficient lateral force is applied to the wrench (along the axis of the body of wrench coupling device 10B). FIG. 1C is a side view of wrench coupling device 10B showing the protrusion of o-ring 7, the depth of channel 5 and the width of shoulder 2 with respect to coupling heads 1C and 1D. Rather than an o-ring extending around the head(s) as shown, an alternative may include other compressible structures that are disposed at least partially around the head(s) such as spring clips, rubber bumps, or the like.

Referring now to FIG. 1C, a wrench coupling device 10C in accordance with another embodiment of the present invention is shown. Wrench coupling device 10C is similar to wrench coupling device 10A of FIG. 1A, so only differences between them will be described below. Magnets 8 are disposed on one or both surfaces of shoulder 2A, which generally has recesses to accommodate magnets 8, which are further secured with an epoxy adhesive or some other suitable attachment mechanism. Magnets 8 magnetically couple a wrench head to wrench coupling device 10C providing a detachable coupling that responds to a level of lateral force along the axis of the body of wrench coupling device 10C to detach a wrench.

Referring now to FIG. 2, construction of a wrench setup is shown using wrench coupling devices 10D, 10E in accordance with an embodiment of the present invention. Wrench coupling devices 10D, 10E may be any of wrench coupling devices 10A-10C as described above, or another coupling device in accordance with another embodiment of the present invention. A first wrench 12A has a box end head that is aligned with a first one of wrench coupling devices 10 and is shown as coupled using o-rings and/or magnets to provide a readily detachable link. Wrench 12B is coupled to both wrench coupling devices 10 and the bottom coupling device 10 is secured to both wrench 12B and wrench 12C using cover plates 14 which feature a knurled edge and threaded studs that extend for threading into the threaded ends of wrench coupling device 10E. Once cover plates 14 are threaded onto wrench coupling device 10E wrenches 12B and 12C are rigidly secured, not only in rotation, but until cover plates 14 are removed, the wrench setup will remain as initially secured. In general, one cover plate 14 may be used to secure a wrench to a wrench coupling device such as wrench coupling device 10E, while the other end of the wrench coupling device is secured only with magnets, an o-ring or remains loosely coupled. Such a configuration ensures that the wrench coupling device will remain secured to the working wrench, i.e., the wrench directly coupled to the nut being turned, while the other wrench can be slipped off to re-set the angle at which force is applied, or to avoid an obstacle.

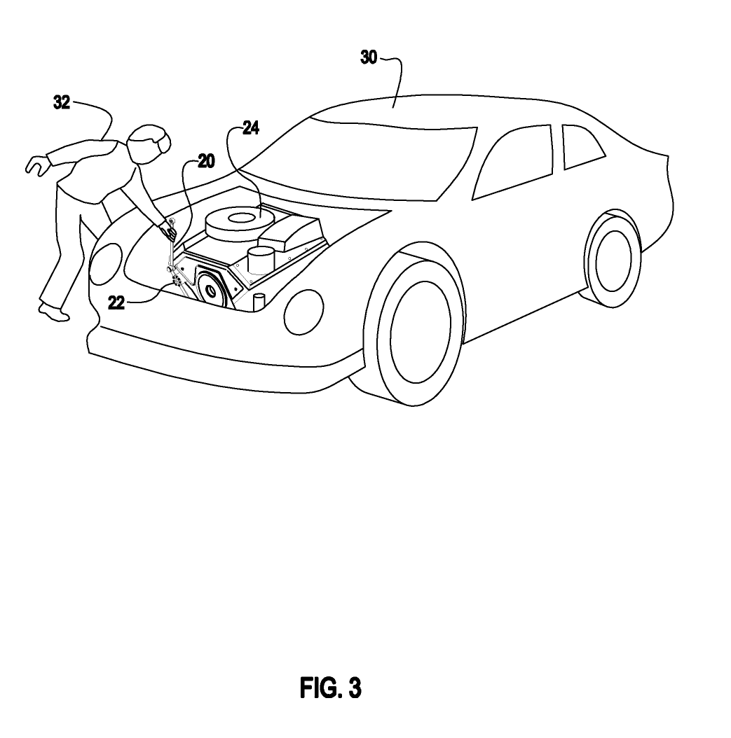

Referring now to FIG. 3, use of a wrench setup is shown. A mechanic 32 uses wrench setup 20 to reach an otherwise hard-to-access nut within an engine compartment 24 of an automobile. An angle between two wrenches forming wrench setup has been set to avoid an obstacle, in this case an alternator that lies in the rotational path of wrench setup 20.

While the invention has been particularly shown and described with reference to the preferred embodiment thereof, it will be understood by those skilled in the art that the foregoing and other changes in form, and details may be made therein without departing from the spirit and scope of the invention.

What is claimed is:

1. A wrench coupling device, comprising a device body having a pair of coupler heads disposed at ends thereof along an axis of the device body, wherein each of the coupler heads is adapted for accepting a head of a corresponding wrench for coupling a pair of wrenches to the wrench coupling device, wherein the wrenches are secured at a fixed angle of rotation with respect to each other when heads of the wrenches are coupled to the coupler heads.

2. The wrench coupling device of claim 1, wherein radial profiles of the pair of coupler heads are polygons having six or more sides.

3. The wrench coupling device of claim 2, wherein radial profiles of the pair of coupler heads are hexagonal.

4. The wrench coupling device of claim 1, wherein the coupler heads of the device each have a different standard wrench size, whereby the device is adapted for coupling two wrenches of different sizes.

5. The wrench coupling device of claim 1, wherein at least one of the ends of the heads defines a threaded recess for accepting a cover plate, wherein the cover plate has a threaded stud extending from an inner face thereof, whereby the cover plate can be affixed to the device for securing a wrench until the cover plate is removed.

6. The wrench coupling device of claim 1, wherein the body further comprises a shoulder disposed between the two coupler heads for contacting faces of wrench heads coupled to each coupler head.

7. The wrench coupling device of claim 6, further comprising magnets disposed on at least one face of the shoulder for magnetically securing a wrench head to the device.

8. The wrench coupling device of claim 1, wherein at least one of the coupler heads defines a channel around a circumference thereof for accepting an o-ring for securing a wrench head to the at least one coupler head by friction between an o-ring and the wrench end.

9. The wrench coupling device of claim 8, further comprising an o-ring inserted in the channel.

10. A method of coupling multiple wrenches, comprising:
providing a first wrench having a first head disposed at a first end thereof;
providing a second wrench having a second head disposed at a second end thereof;
coupling the first wrench and the second wrench by inserting a wrench coupling device, wherein the wrenches are secured at a fixed angle of rotation with respect to each other when heads of the wrenches are coupled to the coupler heads.

11. The method of claim 10, wherein radial profiles of the coupler heads are polygons having six or more sides, and wherein the coupling couples a first wrench and a second wrench having a number of sides compatible with the coupler heads.

12. The method of claim 11, wherein coupler heads have hexagonal profiles.

13. The method of claim 10, wherein the coupler heads of the device each have a different standard wrench size, whereby the coupling couples wrench heads of two different sizes.

14. The method of claim 10, further comprising securing the first wrench to the wrench coupling device with a detachable cover plate that removably attaches to the first coupler head.

15. The method of claim 10, further comprising preventing the first coupler head from sliding through the second wrench head by providing a shoulder disposed between the two coupler heads.

16. The method of claim 10, further comprising magnetically securing the first wrench head to the device.

17. The method of claim 10, further comprising securing a wrench head to the first coupler head by friction between an o-ring disposed around the first coupler head and the wrench end.

18. The method of claim 10, further comprising inserting o-ring inserted in a channel disposed around the first coupler head.

19. A wrench coupling device, comprising a device body having a first hexagonal head disposed at a first end thereof, a second hexagonal head disposed at a second end thereof, and a shoulder disposed between the first hexagonal head and the second hexagonal head, whereby a pair of wrenches can be secured to the first and second hexagonal heads, the shoulder preventing passage of either of the hexagonal heads completely through ends of the wrenches, wherein the wrenches can be secured at a fixed angle of rotation with respect to each other when heads of the wrenches are coupled to the first and second hexagonal heads.

20. The wrench coupling device of claim 19, further comprising means for detachably securing at least one of the wrenches to the wrench coupling device.
